(19) United States
(12) Patent Application Publication
(10) Pub. No.: US 2010/0285195 A1
(43) Pub. Date: Nov. 11, 2010

(54) Methods of Making Sweetener Compositions

(76) Inventors: Leanne Fisher, Reading (GB); Carole Ann Bingley, Reading (GB); Marion Magdalena Horn, Reading (GB); Peter Horn, Reading (GB)

Correspondence Address: CANTOR COLBURN, LLP, 20 Church Street, 22nd Floor, Hartford, CT, 06103, US

(21) Appl. No.: 12/527,453

(22) PCT Filed: Feb. 21, 2008
(86) PCT No.: PCT/GB08/00586

§ 371 Date: Apr. 13, 2010

(30) Foreign Application Priority Data
Feb. 23, 2007 (GB) 0703525.6

(51) Int. Cl. A23L 1/236; A23L 1/28; A23L 2/60

(52) U.S. Cl. 426/492

(57) ABSTRACT

A method of improving the taste of an extract of a fruit from the Cucurbitaceae family provided as a liquid comprising the extract is offered, said method comprising heating the liquid to a temperature above 60° C. such that at least one off-flavor material is removed by evaporation. The use of the method in making a beverage or a foodstuff is also disclosed.

The present invention relates to methods of making sweetener compositions.

Lo Han Guo (hereinafter called “LHG”), sometimes spelled Lo Han Kuo, is the common name for the Chinese fruit Momordica grosvenorii (Swingle), also called Siraitia grosvenorii, belonging to the Cucurbitaceae family. Siraitia grosvenorii is an herbaceous perennial vine native to southern China and best known for its fruit, the LHG. Botanical synonyms include Momordica grosvenorii and Thladiantha grosvenorii.

The fruit is well known for its sweet taste. The fruit extract is many times sweeter than sugar, and has been used as a natural sweetener in China for nearly a millennium due to its flavor and low level of food energy.

Agric. Biol. Chem., 53 (12). 3347˜3349, 1989 Sweet Cucurbitane Glycosides from Fruits of Siraitia siamensis (chi-zi-Lo-han-guo), a Chinese Folk Medicine by Ryoji KASAI, Rui-Lin Nie, Kenji NASHI, Kazuhiro OHTANI, Jun ZHOU, Guo-Da TAO and Osamu TANAKA describes a laboratory scale process for the isolation of various glycosides from LHG using chromatography on a highly porous polymer, then on silica gel and finally by HPLC (high performance liquid chromatography) on a reverse phase column.

The compounds which provide the sweet taste of LHG comprise a group of triterpene glycosides including mogroside IV, mogroside V, 11-oxo-mogroside V and siamenoside I. The most abundant triterpene glycoside component of LHG is mogroside V. Mogroside V is reported to be 300 times sweeter than sucrose, and occurs in the fruit at concentrations up to 1% wt. Through extraction, a powder containing up to 80% mogrosides can be obtained. The chemical structure of mogroside V is shown below.

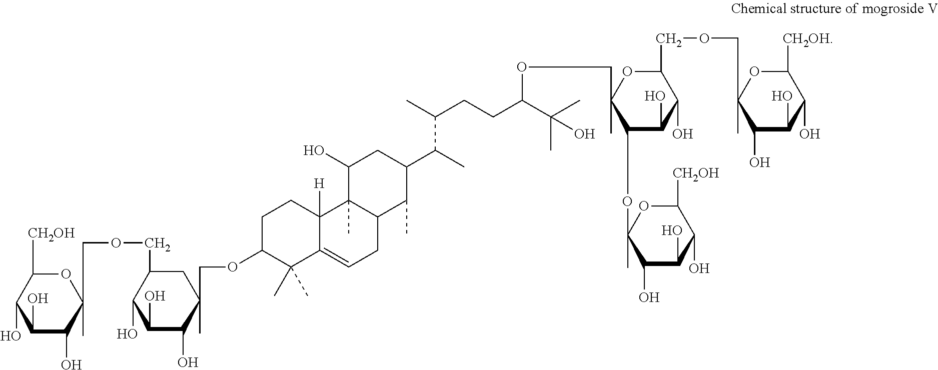

LHG is harvested in the form of a round green fruit, which becomes brown upon drying. It is rarely used in its fresh form, as it is hard to store.

Processing of LHG usually results in several non-sweet off flavors. These flavors limit the use of the extracts as a sweetener to products that additionally have sugar or honey added to them, thereby masking the undesirable off flavors. The use of LHG as a natural high intensity sweetener is therefore limited for inclusion at low levels in soft drinks, and foodstuffs due to the very distinctive flavor. Commercially available LHG is therefore not currently suitable for use as a sole sweetener, and must be used in combination with other sweeteners to achieve the required sweetness intensity.

LHG has been used in beverage formulations as an alternative sweetener to sucrose but it is not necessarily used exclusively in low calorie drinks. In beverages, there is a move towards using natural sweeteners as an alternative to sucrose and artificial high intensity sweeteners, and therefore LHG is of interest for such a use.

There have been many attempts to reduce the off-flavors in LHG in order to provide beverages which have natural sweeteners.

Various processes have been proposed to modify LHG to provide a natural sweetener with less bitterness. U.S. Pat. No. 5,411,755 confirms that, whilst LHG is very sweet, it has too many interfering aromas therefore rendering it useless for general application. U.S. Pat. No. 5,411,755 describes a laboratory scale process comprising the steps of separating peel, seeds and some fruit pulp from the juice of the fruit, optionally acidifying the juice, removing off-flavor precursors from the juice, removing a volatiles fraction containing off-flavor materials from the juice and optionally, concurrently concentrating the juice. In one example unspecified off-flavors are removed by evaporation using a laboratory rotary evaporator system in which the bath temperature is 52° C. to 54° C. The application also contemplates the removal of unspecified off-flavor precursors using certain exchange resins, adsorbents, fining agents and precipitating agents. The removed volatiles can be totally or partially recovered, concentrated and used for other feed applications, added back to the juice or discarded.

WO 94/18855 describes a natural sweetening composition using a flavoring system comprising sweet juice derived from the botanical genus/species Siraitia grosvenorii, S. siamensis, S. silomaradjae, S. sikkimensis, S. africana, S. borneensis, S. taiwaniana or mixtures thereof. The composition further comprises sugar and optionally an edible acid and/or edible salt. Evaporation is said to remove much of the undesirable flavor notes from the juice in a laboratory scale process. However, low temperatures are preferred for such evaporation. In one example 52° C. to 54° C. is used as the bath temperature for a laboratory rotary evaporator. The unspecified removed volatiles can be totally or partially recovered, concentrated and used for other feed flavor applications, added back to the juice or discarded.

Both U.S. Pat. No. 5,411,755 and WO 94/18855 are laboratory scale processes largely directed to the preparation of beverages direct from the fruit.

LHG is conventionally supplied to end users as a powder. It has been found that commercially available materials contain a plethora of compounds, which are not sweet.

The present invention seeks to provide a method of improving the taste of an extract of a fruit from the Cucurbitaceae family, the modified extract having improved sweetness and reduced bitter taste characteristics.

According to one embodiment of the invention there is provided a method of improving the taste of an extract of a fruit from the Cucurbitaceae family provided as a liquid comprising the extract, said method comprising heating the liquid to a temperature above 60° C. such that at least one off-flavor material is removed by evaporation.

According to an alternative embodiment, there is provided the use of the method of improving the taste of an extract of a fruit from the Cucurbitaceae family in making a beverage or a foodstuff.

The removal of volatile off-flavor material, by heating leaves a cleaner residue with an enhanced sweetness profile. Generally heating takes place in an open or otherwise vented container and the volatile off-flavor material is dispersed into the atmosphere or collected for disposal.

The removal of off-flavors provides a purified extract which has significantly reduced off-taste properties when compared to known extracts or LHG compositions. The reduced off-tastes of the extract therefore allows for use of the extract in higher amounts than previously disclosed, thereby obtaining the advantages of a natural sweetener with reduced off-taste properties.

As used herein, the term “an extract of a fruit from the Cucurbitaceae family” refers to extracts obtained from the plant of the family Cucurbitaceae, tribe Jollifieae may be used, for instance sub-tribe Thladianthinae, in some embodiments genus Siraitia. The extract of a fruit from the Cucurbitaceae family may be from the genus/species S. grosvenorii, S. siamensis, S. silomaradjae, S. sikkimensis, S. africana, S. borneensis, and S. taiwaniana. The fruit of the genus/species S. grosvenorii, is often called Lo Han Guo fruit.

Although the following description of the resulting products of the method of this invention is made with particular reference to making an LHG extract, other extracts of the Cucurbitaceae family which contain at least 0.01% sweet triterpene glycosides or mogrosides are useful in this invention. In some embodiments, the extracts will contain more than 0.1% to about 90% mogrosides, and usually from 70% to 90% mogrosides prior to dilution. The extracts may include at least one of mogroside V, mogroside IV, 11-oxo-mogroside V, siamenoside and mixtures thereof.

The extract of the fruit from the Cucurbitaceae family may be used in the form of sweet juices, purees, solutions, pastes, or serums. The extract may alternatively be in the form of a solid, such as powders, granules, flakes, pellets, or any combination thereof, solvated to provide a liquid. The extract may be in a diluted or concentrated form.

Alternatively, the extract of a fruit from the Cucurbitaceae family may be in the form of a composition which comprises an amount of extract from the fruit in combination with other suitable ingredients or excipients. The composition may also be in the form of a solution that is formed from addition of a sweet juice, puree, solution, paste, serums, or solid such powders, granules, flakes, or pellets, of an extract of a fruit from the Cucurbitaceae family with a suitable solvent, such as water for example.

The extract of a fruit from the Cucurbitaceae family may be in the form of a solid which is solvated in a suitable solvent, such as water.

This method is particularly useful in the industrial production of beverages and foodstuffs, such as confectionery and chewing gum. It is both cost-effective and easy to achieve on-line in the manufacturing plant. The extract produced by the method of the present invention may be used for full or partial replacement of sugar or artificial sweeteners.

Typically the fruit extract, such as Lo Han Guo, is initially provided in solid form, usually as a powder. The method contemplates dissolving this, optionally in water so as to provide a solution of the fruit extract. During this process the mogrosides content of the solid material may be typically reduced from about 70%-90% to 0.01%-15%. It is this re-constituted fruit extract that is subjected to heat to permanently remove volatiles of untreated off-flavour materials, some of which may have developed in the fruit extract during the processing of the raw fruit into dry powder. The purified fruit extract may then be utilized in liquid form as is useful in beverages and some foodstuffs, or possibly dried.

The heating of the extract may take place in a system which is substantially open to the atmosphere, or alternatively a closed or substantially closed system which provides for removal of off-flavor compounds from the extract for disposal.

Suitable closed or substantially closed systems include apparatus where the evaporated volatile may be collected and not returned to the extract. By way of example, such apparatus includes apparatus for simple distillation, fractional distillation, steam distillation, vacuum distillation, air-sensitive vacuum distillation, azeotropic distillation, short path distillation, spinning cone distillation, or continuous distillation.

Heating of the extract may be by any suitable method. Suitable methods may include, by way of example, microwaves, oven or flame, steam, water, electric heat (hob), halogen hob, or any suitable indirect heat.

The extract may be heated to a suitable temperature for the off-flavor materials from the extract.

Suitable temperatures for the removal of off flavor compounds from the extract would be at least 60° C. In one embodiment, the extract is heated to at least 65° C. and in a further embodiment to at least 70° C. In a still further embodiment of the invention the extract would be heated to at least 80° C.

Heating the extract to a temperature of about 90° C. is found to be particularly useful for removal of the off-flavor materials from the extract.

The extract may be held at the desired temperature for a predetermined period of time.

Suitable time periods of time may for indirect heating (such as by flame, oven, hob, or microwave heating), for example, be in the range from 1 second and 10 minutes. Alternative periods of time are in the range from 30 seconds and 5 minutes or in the range from 1 minute to 3 minutes.

Suitable periods of time for distillation will depend on the distillation method but will generally be within the range 1 second and 4 hours, in some embodiments in the range 1 second and 1 hour.

It is found that heating in a completely closed system, with no removal of volatiles, does not provide for removal of the off flavor materials from the extract, and therefore does not provide an extract in which the off-flavors are substantially removed.

One embodiment of the method of the invention works well when the fruit extract solution, such as solvated LHG solid, is acidified. Organic as well as inorganic edible acids are suitable for this purpose. Possible acids include citric acid, malic acid, adipic acid, fumaric acid, gluconic acid, tartaric acid, ascorbic acid, acetic acid, phosphoric acid or mixtures of any of the aforesaid. Citric acid is a particularly useful acidic component. The pH of the acidified solution may be in the range from pH 2.0 to pH 5.5. The acid may be buffered.

In an alternative embodiment of the invention, particularly but not exclusively using distillation, a substantially neutral solution or mildly acidic or alkaline solution is used having a pH in the range from 5.5-8.5, or from 6.0-8.0 and in some embodiments from 6.5 from 7.5.

In one embodiment of the invention acid distillation has provided good results.

In one embodiment of the invention it may be desired to add off-flavor taste masking ingredients to the fruit extract before, after, or both before and after the processing according to the invention. Such masking ingredients may include any combination of sugar alcohols, salts and saccharides, as desired, to facilitate reduction of the bitter taste of the fruit extract.

Suitable sugar alcohols, by way of example, may include erythritol, isomalt, lactitol, maltitol, mannitol, sorbitol, xylitol, or any combination thereof.

The sugar alcohol may be present in the range from 0.1 wt. % to 10 wt. % of the sweetener composition and in some embodiments, in the range from 1.0 wt. % to 3.0 wt. %.

Salts of alkali metal and alkaline earth metal cations may be used as taste masking agents. Suitable salts include, by way of example, salts of the cations of calcium, sodium, magnesium, zinc, and potassium.

In one embodiment organic salts are used as flavor masking agents. The organic acid salts may be salts of monocarboxylic or dicarboxylic organic acids. Salts of monocarboxylic acids having a carbon chain length from C1-C10 are often appropriate, such as salts of monocarboxylic acids having a linear, optionally branched, backbone having a carbon chain length from C1-C10, and ideally from C1-C6. In some embodiments, the salts include at least one of a gluconate and/or a lactate.

Suitable organic salts include, by way of example, calcium lactate, magnesium lactate, sodium lactate, calcium gluconate, magnesium gluconate, and sodium gluconate. Magnesium gluconate may be used in an embodiment of the invention.

The organic salts may be present in the range from 0.001 wt. % to 1.0 wt. % of the sweetener composition or in the range from 0.01 wt. % to 0.05 wt. %.

The organic salts may be used alone or in any suitable combination.

The organic salts and sugar alcohols may be used in the sweetener composition in any suitable combination.

The sweetener composition may also additionally comprise at least one saccharide. The saccharide may comprise one or more monosaccharides, disaccharides and polysaccharides either alone or in combination.

Suitable monosaccharides might be selected from the following groups:
Trioses—for example glyceraldehydes, or dihydroxyacetone
Tetroses—for example erythrose, threose, or erythrulose
Pentoses—for example arabinose, lyxose, ribose, xylose, ribulose, or xylulose
Hexoses—allose, altrose, galactose, glucose, glucose, idose, mannose, talose, fructose, psicose, sorbose, or tagatose
Heptoses—for example mannoheptulose, or sedoheptulose
Octoses—for example octolose, or 2-keto-3-deoxy-manno-octonate,
Nonoses—for example sialose.

Suitable disaccharides may be selected from sucrose, lactose, maltose, trehalose, or cellobiose, for example. Suitable polysaccharides may include starch and glycogen.

The saccharides, may be present in the range 0.01 wt. % to 10.0 wt. % of the sweetener composition and may be present in the range 0.2 wt. % to 1.0 wt. %.

The saccharides may be used alone or in any suitable combination.

The saccharides, sugar alcohols and organic salts may be used in the sweetener composition in any suitable combination. Suitable combinations include, by way of example;
erythritol with tagatose and magnesium gluconate;
erythritol with tagatose and magnesium lactate;
malitol with tagatose and magnesium lactate; and
malitol with tagatose and calcium gluconate.

The extract of a fruit from the Cucurbitaceae family produced by the method of the present invention, especially when concentrated or dried, can be used as a sweetener for many purposes. Examples of such uses as a sweetener include addition to edible products such as;
beverages, such as tea, coffee, fruit juice and fruit-flavored beverages;
foods, such as jams and jellies, peanut butter, pies, puddings, cereals, candies, confectionary, ice creams, yogurts, and popsicles;
health care products, such as dentifrices, mouthwashes, cough drops, cough syrups;
chewing gum;
use generally as a sugar substitute.

An extract of a fruit from the Cucurbitaceae family as prepared by the method of the present invention provides for development of a low calorie beverage that is sweetened without the inclusion of synthetic high intensity sweeteners.

The extract is added to the edible product in an amount sufficient to provide a sweetening sensation.

The edible product may comprise the extract processed according to the present invention in an amount from 0.001 wt. % to 2.0 wt. %, or alternatively in an amount from 0.01 wt. % to 1.0 wt. %, in some embodiments in an amount from 0.01 wt. % to 0.1 wt. % and or in an amount from 0.02 wt. % to 0.08 wt. %. When used in chewing gum, the chewing gum may comprise from 0.02 wt % to 1 wt. % of the extract processed according to the present invention.

It is envisaged that the extract provided by the method of the present invention may be used in the form of a sweet juice, puree, paste, solution, serum, or solid, such powders, granules, flakes, or pellets, which may be in a diluted or concentrated form.

The extract in the form of a sweet juice, puree, solution, paste, or serum may be concentrated or possibly dried to produce a solid form, such as a powder, granule, flake, or pellet, which is used in a foodstuff or beverage.

The edible product may be coated with the extract produced by the method of the present invention for use in, for example, batters, frozen foods, sauces, fillings, and other nutritive ingredients. Examples of frozen foods include sauces, desserts, pastries and the like.

For the batters of cakes, cookies, breads, pastries and pie doughs, the extract may typically be included with the water. The amounts of components, and the ingredients used in the batter composition are those amounts and ingredients typically used in preparing baked foods. The compositions can be prepared according to any method.

The extract may be combined with additional ingredients such as flavoring systems.

Flavoring systems comprising fruit extract processed according to the method of the present invention can also comprise flavors selected from fruit flavors, botanical flavors and mixtures thereof. Citrus flavors include orange flavors, lemon flavors, lime flavors, and grapefruit flavors. Besides citrus flavors, a variety of other fruit flavors can be used such as apple flavors, grape flavors, cherry flavors, pineapple flavors and the like. These fruit flavors can be derived from natural sources such as fruit juices and flavor oils, or else may be synthetically prepared.

The flavoring agents may be used in liquid or solid form and may be used individually or in admixture. Commonly used flavors include mints such as peppermint, menthol, spearmint, artificial vanilla, cinnamon derivatives, and various fruit flavors, whether employed individually or in admixture. Flavors may also provide breath freshening properties, particularly the mint flavors when used in combination with cooling agents.

The flavoring systems may also comprise milk or milk type flavors. Tea or tea flavor types are another possible component of a flavoring system.

Beverages comprising the extract processed according to the invention can also comprise a mineral supplementation or a vitamin supplementation or mixtures thereof. The mineral supplementation may comprise calcium, potassium, magnesium, iron, sodium or mixtures of these minerals. Also trace mineral supplementation can be incorporated in the beverages. Amounts and methods for incorporation of the mentioned minerals are well known in the art. The level of the minerals is selected so as not to deteriorate the taste characteristics of the beverage composition.

Supplemented ascorbic acid (i.e. vitamin C) may be added to the beverage in an amount of up to 0.15%. Supplemented ascorbic acid is that which is added to the beverage and does not include that which may be incorporated by the flavoring system and the extract. The ascorbic acid should be easily solubilized in the beverage. It can be synthetic or natural, for example extracted from fruits or vegetables.

Other optional ingredients typically present in fruit or vegetable juice can be included in the beverages. For example, preservatives, pharmaceuticals, nutraceuticals, vitamins and other minerals can be included. Suitable vitamins include A, D, E, B1, B2, B6, B12, K, niacin, panthotenic acid, folic acid, biotin, and beta carotene. Other minerals which can be included are calcium, zinc, manganese, copper, and other trace minerals. If desired, natural and synthetic colorings, and flavorings can be included in these beverages.

### Use of the Invention in Chewing Gum

As discussed previously, the invention has application in chewing gum technology.

The sweetener composition produced by the invention may be used as a bulk sweetener in chewing gum. For coated gums, the sweetener may additionally, or alternatively, be used in the coating. The sweetener composition may be used as the sole sweetener or alternatively in combination with one or more other sweeteners.

The elastomers (rubbers) employed in the gum base of the chewing gum will vary greatly depending upon various factors such as the type of gum base desired, the consistency of gum composition desired and the other components used in the composition to make the final chewing gum product. The elastomer may be any water-insoluble polymer known in the art, and includes those gum polymers utilized for chewing gums and bubble gums. Illustrative examples of suitable polymers in gum bases include both natural and synthetic elastomers. For example, those polymers which are suitable in gum base compositions include, without limitation, natural substances (of vegetable origin) such as chicle, natural rubber, crown gum, nispero, rosidinha, jelutong, perillo, niger gutta, tunu, balata, guttapercha, lechi capsi, sorva, gutta kay, and the like, and combinations thereof. Examples of synthetic elastomers include, without limitation, styrene-butadiene copolymers (SBR), polyisobutylene, isobutylene-isoprene copolymers, polyethylene, polyvinyl acetate and the like, and combinations thereof. Specific examples of elastomers include polyisobutylene, styrene butadiene rubber, butyl rubber, and combinations thereof.

Additional useful polymers include: polybutylmethacrylate/acrylic acid copolymers, polyvinylacetate/vinylalcohol copolymers, microcrystalline cellulose, sodium carboxymethyl cellulose, hydroxylpropylmethyl cellulose, crosslinked cellulose acetate phthalate, crosslinked hydroxyl methyl cellulose polymers, zein, crosslinked polyvinyl pyrrolidone, polymethylmethacrylate/acrylic acid copolymers, copolymers of lactic acid, polyhydroxyalkanoates, plasticized ethylcellulose, polyvinyl acetatephthalate and combinations thereof.

In addition to the components set out above, the gum base may include a variety of other ingredients, such as components selected from elastomer solvents, emulsifiers, plasticizers, fillers, and mixtures thereof. As mentioned above, the use of elastomer solvents is not needed to masticate the rubber during the manufacturing process. It may be present in limited amounts, but can lessen from the non-stick properties of the gum base if used in amounts above about 5% by weight of the gum base. In certain embodiments, elastomer solvents may be used in amounts of about 4% to about 5% by weight of the gum base to provide non-stick properties which are sufficient to provide non-stick properties to teeth, dentures, oral implants and other oral prosthetics.

In some embodiments, the gum base may also contain less than conventional amounts of elastomer solvents to aid in softening the elastomer component. In particular, in some embodiments, such solvents are not required, but may be used in limited amounts along with the non-stick and/or degradability inducing components. By less than conventional amounts is meant that the elastomer solvent is employed in the gum base, for example, in amounts from about 0% to about 5.0% and in some examples from about 0.1% to about 3.0%, by weight, of the gum base. In some embodiments, the gum base includes a maximum of about 5.0% by weight of an elastomer solvent. In other embodiments, the gum base is free of added elastomer solvents. In some embodiments the gum base is also free of added waxes.

In some embodiments, the gum base may include bulking agents that are water-insoluble and/or mineral-based. In particular, the gum base also may include effective amounts of bulking agents such as mineral adjuvants which may serve as fillers and textural agents. Useful mineral adjuvants include calcium carbonate, magnesium carbonate, alumina, aluminum hydroxide, aluminum silicate, talc, starch, tricalcium phosphate, dicalcium phosphate, calcium sulfate, atomite, and the like, and mixtures thereof. These fillers or adjuvants may be used in the gum base compositions in various amounts. The filler may be present in an amount from about zero to about 60% by weight of the gum base and/or composition, or from about zero to about 50% by weight and, in an alternative embodiment, from about zero to about 40%, by weight, of the gum base and/or chewing gum composition. In some embodiments, the filler may be present in an amount from about zero to about 30% by weight of the gum base and/or chewing gum composition. Moreover, in some embodiments, the amount of filler will be from about zero to about 15% by weight of the gum base and/or chewing gum composition, or from about 3% to about 11%, by weight, of the gum base and/or chewing gum composition. In other embodiments, the amount of filler, when used, may be present in an amount from about 15% to about 40% or, from about 20% to about 30% by weight of the gum base.

The chewing gum compositions may include one or more bulk sweeteners in addition to the sweetener composition produced by the method of the invention, such as sugars, sugarless bulk sweeteners, or the like, or mixtures thereof. In some embodiments the total amount of bulk sweeteners is in the range from about 5% to about 99% by weight of the chewing gum composition.

Intense sweetening agents may be used in many distinct physical forms well-known in the art to provide an initial burst of sweetness and/or a prolonged sensation of sweetness. Without being limited thereto, such physical forms include free forms, such as spray dried, powdered, beaded forms, encapsulated forms, and mixtures thereof.

The chewing gum compositions also may include flavors (i.e., flavorings or flavor agents). Flavors which may be used include those flavors known to the skilled artisan, such as natural and artificial flavors. These flavors may be chosen from synthetic flavor oils and flavoring aromatics and/or oils, oleoresins and extracts derived from plants, leaves, flowers, fruits, and so forth, and combinations thereof. The flavors may be used in liquid or solid form and may be used individually or in admixture. Commonly used flavors include mints such as peppermint, menthol, spearmint, artificial vanilla, cinnamon derivatives, and various fruit flavors, whether employed individually or in admixture.

Additional additives, such as sensates including physiological cooling agents; warming agents and tingling agents; throat-soothing agents; spices; herbs and herbal extracts, tooth-whitening agents; breath-freshening agents; vitamins and minerals; bioactive agents; caffeine; nicotine; drugs and other actives may also be included in any or all portions or regions of the chewing gum products. Such components may be used in amounts sufficient to achieve their intended effects.

Suitable cooling agents are further described in the following U.S. patents, all of which are incorporated in their entirety by reference hereto: U.S. Pat. Nos. 4,230,688 and 4,032,661 to Rowsell et al.; 4,459,425 to Amano et al.; 4,136,163 to Watson et al.; 5,266,592 to Grub et al.; and U.S. Pat. No. 6,627,233 to Wolf et al. Cooling agents are generally present in amount of 0.01% to about 10.0%.

Warming agents may be selected from a wide variety of compounds known to provide the sensory signal of warming to the individual user. These compounds offer the perceived sensation of warmth, particularly in the oral cavity, and often enhance the perception of flavors, sweeteners and other organoleptic components.

Tingling agents may provide a tingling, stinging or numbing sensation to the user. In some embodiments, a sensation is created due to effervescence. Such effervescence is created by combining an alkaline material with an acidic material, either or both of which may be encapsulated. Examples of “tingling” type sensates can be found in U.S. Pat. No. 6,780,443, the entire contents of which are incorporated herein by reference for all purposes. Tingling agents are described in U.S. Pat. No. 6,780,443 to Nakatsu et al., U.S. Pat. No. 5,407,665 to McLaughlin et al., U.S. Pat. No. 6,159,509 to Johnson et al. and U.S. Pat. No. 5,545,424 to Nakatsu et al., each of which is incorporated by reference herein in its entirety.

A variety of oral care products also may be included in some embodiments of the instant chewing gum compositions. Such oral care products may include tooth whiteners, stain removers, anti-calculus agents, and anti-plaque agents. Examples are included in the following U.S. patents which are incorporated in their entirety herein by reference: U.S. Pat. Nos. 5,227,154 to Reynolds, 5,378,131 to Greenberg and 6,685,916 to Holme et al. Suitable oral care actives such as remineralization agents, antimicrobials, and tooth-whitening agents are described in assignee's co-pending U.S. patent application Ser. No. 10/901,511, filed Jul. 29, 2004 and entitled “Tooth-Whitening Compositions and Delivery Systems Therefor,” which is incorporated herein by reference in its entirely, and the like, and mixtures thereof.

A variety of drugs, including medications, herbs, and nutritional supplements may also be included in the chewing gum compositions.

Examples of active ingredients contemplated for use in the present inventive chewing gum compositions include antacids, H2-antagonists, and analgesics. For example, antacid dosages can be prepared using the ingredients calcium carbonate alone or in combination with magnesium hydroxide, and/or aluminum hydroxide. Moreover, antacids can be used in combination with H2-antagonists.

A variety of other nutritional supplements also may be included in the gum compositions. Virtually any vitamin or mineral may be included. Examples of nutritional supplements are set forth in U.S. Patent Application Publication Nos. 2003/0157213 A1, 2003/0206993 and 2003/0099741 A1, which are incorporated in their entirety herein by reference.

Acidulants also may be included in the chewing gum compositions. Suitable acidulants include, for example, malic acid, adipic acid, citric acid, tartaric acid, fumaric acid, and mixtures thereof.

Any of the aforementioned additives for use in a chewing gum composition, as well as other conventional additives known to one having ordinary skill in the art, such as thickeners, may be incorporated into the chewing gum base of the chewing gum compositions or any coating that the chewing gum product may contain.

The chewing gum compositions may be formed into a variety of shapes and sizes and may take various product forms, including without limitation, sticks, slabs, chunks, balls, pillows, tablet, pellet, center-filled, pressed tablet, deposited, compressed chewing gum or any other suitable format, as well as coated and uncoated forms.

When the chewing gum compositions are formed into coated products, the coating may be applied by any method known in the art. The coating composition may be present in an amount from about 2% to about 60%, or from about 25% to about 35% by weight of the total center-filled gum piece, in some embodiments from about 25% to about 45% by weight of the total chewing gum piece or, in an amount about 30% by weight of the gum piece.

Such coated chewing gums are typically referred to as pellet gums. The outer coating may be hard or crunchy. Any suitable coating materials known to those skilled in the art may be employed. Typically, the outer coating may include the sweetener composition produced by the invention, optionally in combination with any of sorbitol, maltitol, xylitol, isomalt, erythritol, isomalt, and other crystallizable polyols; sucrose may also be used. Furthermore, the coating may include several opaque layers, such that the chewing gum composition is not visible through the coating itself, which can optionally be covered with a further one or more transparent layers for aesthetic, textural and protective purposes. The outer coating may also contain small amounts of water and gum arabic. The coating can be further coated with wax. The coating may be applied in a conventional manner by successive applications of a coating solution, with drying in between each coat. As the coating dries it usually becomes opaque and is usually white, though other colorants may be added. A polyol coating can be further coated with wax. The coating can further include colored flakes or speckles. If the composition includes a coating, it is possible that one or more oral care actives can be dispersed throughout the coating. This is especially useful if one or more oral care actives is incompatible in a single phase composition with another of the actives. Flavors may also be added to yield unique product characteristics.

Other materials may be added to the coating to achieve desired properties. These materials may include, without limitations, cellulosics such as carboxymethyl cellulose, gelatin, xanthan gum, and gum arabic.

For instance, center-fill chewing gum embodiments may include a center-fill region, which may be a liquid or powder or other solid, and a gum region. Some embodiments also may include an outer gum coating or shell, which typically provides a crunchiness to the piece when initially chewed. The outer coating or shell may at least partially surround the gum region.

Some other chewing gum embodiments may be in a compressed gum format, such as, for example, a pressed tablet gum. Such embodiments may include a particulate chewing gum base, which may include a compressible gum base composition and a tableting powder.

Use of the Invention in Combination with a Taste Potentiator

The sweetener compositions produced by the method of the invention may be used in combination with a taste potentiator, for example in beverages. Such compositions would include the sweetener composition, as at least one active ingredient substance, and optionally one or more other ingredients and a taste potentiator which may increase the perception of the active substance.

In some embodiments, the active substance(s) included in the potentiator compositions may be present in amounts of about 1% to about 95% by weight of the composition, or about 5% to about 30% by weight of the composition.

Any of a variety of substances that function as taste potentiators may be employed in the compositions described herein. For instance, suitable taste potentiators include water-soluble taste potentiators.

The active substance(s) may comprise any component for which the perception is enhanced in some manner by the presence of one or more taste potentiators. Suitable active substances include, but are not limited to, compounds that provide flavor, sweetness, tartness, umami, kokumi, savory, saltiness, cooling, warmth or tingling. Other suitable actives include oral care agents, nutraceutical actives and pharmaceutical actives. Combinations of active substances also may be employed.

Compounds that provide flavor (flavorings or flavor agents), which may be used include those flavors known to the skilled artisan, such as natural and artificial flavors. These flavorings may be chosen from synthetic flavor oils and flavoring aromatics and/or oils, oleoresins and extracts derived from plants, leaves, flowers, fruits, and so forth, and combinations thereof. The flavoring agents may be used in liquid or solid form and may be used individually or in admixture. Commonly used flavors include mints such as peppermint, menthol, spearmint, artificial vanilla, cinnamon derivatives, and various fruit flavors, whether employed individually or in admixture. Flavors may also provide breath freshening properties, particularly the mint flavors when used in combination with cooling agents.

In some embodiments, the flavor agent may be employed in either liquid form and/or dried form. When employed in the latter form, suitable drying means such as spray drying the oil may be used. Alternatively, the flavor agent may be absorbed onto water soluble materials, such as cellulose, starch, sugar, maltodextrin, gum arabic and so forth or may be encapsulated. The actual techniques for preparing such dried forms are well-known.

In some embodiments, the flavor agents may be used in many distinct physical forms well-known in the art to provide an initial burst of flavor and/or a prolonged sensation of flavor. Without being limited thereto, such physical forms include free forms, such as spray dried, powdered, beaded forms, encapsulated forms, and mixtures thereof.

Compounds that provide sweetness (sweeteners or sweetening agents) may be included in addition to the sweetener compositions. These may include additional bulk sweeteners such as sugars, sugarless bulk sweeteners, or the like, or mixtures thereof.

Intense sweetening agents may be used in many distinct physical forms well-known in the art to provide an initial burst of sweetness and/or a prolonged sensation of sweetness. Without being limited thereto, such physical forms include free forms, such as spray dried, powdered, beaded forms, encapsulated forms, and mixtures thereof.

Compounds that provide tartness may include acidulants, such as acetic acid, adipic acid, ascorbic acid, butyric acid, citric acid, formic acid, fumaric acid, glyconic acid, lactic acid, phosphoric acid, malic acid, oxalic acid, succinic acid, tartaric acid and mixtures thereof.

Compounds that provide umami or savory flavor may include monosodium glutamate (MSG), glutamic acid, glutamates, aspartate, free amino acids, IMP (disodium 5′-inosine monophosphate) and GMP (disodium 5′-guanosine monophosphate), compounds that stimulate T1R1 and T1R3 receptors, mushroom flavor, fermented fish flavor, and muscle flavors, such as beef, chicken, pork, ostrich, venison and buffalo.

Substances that impart kokumi may include a mixture selected from: gelatin and tropomyosin and/or tropomyosin peptides; gelatin and paramyosin; and troponin and tropomyosin and/or tropomyosin peptides, as disclosed in U.S. Pat. No. 5,679,397 to Kuroda et al., referred to above.

Compounds that provide saltiness may include conventional salts, such as sodium chloride, calcium chloride, potassium chloride, 1-lysine and combinations thereof.

Compounds that provide a cooling sensation may include physiological cooling agents. A variety of well known cooling agents may be employed. Examples of suitable cooling agents are described in the following U.S. patents, all of which are incorporated in their entirety by reference hereto: U.S. Pat. Nos. 4,230,688; 4,032,661; 4,459,425; 4,136,163; 5,266,592; 6,627,233.

Compounds that provide warmth (warming agents) may be selected from a wide variety of compounds known to provide the sensory signal of warming to the individual user. These compounds offer the perceived sensation of warmth, particularly in the oral cavity, and often enhance the perception of flavors, sweeteners and other organoleptic components. Useful warming agents include those having at least one allyl vinyl component, which may bind to oral receptors.

Compounds that provide a tingling sensation also are known and referred to as “tingling agents.” Tingling agents may be employed to provide a tingling, stinging or numbing sensation to the user. In some embodiments, a sensation is created due to effervescence. Such effervescence is created by combining an alkaline material with an acidic material, either or both of which may be encapsulated. Examples of “tingling” type sensates can be found in U.S. Pat. No. 6,780,443, the entire contents of which are incorporated herein by reference for all purposes. Tingling agents are described in U.S. Pat. No. 6,780,443 to Nakatsu et al., U.S. Pat. No. 5,407,665 to McLaughlin et al., U.S. Pat. No. 6,159,509 to Johnson et al. and U.S. Pat. No. 5,545,424 to Nakatsu et al., each of which is incorporated by reference herein in its entirety.

Oral care agents that may be used include those actives known to the skilled artisan, such as, but not limited to, surfactants, breath freshening agents, anti-microbial agents, antibacterial agents, anti-calculus agents, anti-plaque agents, oral malodor control agents, fluoride compounds, quaternary ammonium compounds, remineralization agents and combinations thereof.

Other oral care actives known to those skilled in the art are considered well within the scope of the present invention.

Pharmaceutical actives include drugs or medicaments, breath fresheners, vitamins and other dietary supplements, minerals, caffeine, nicotine, fruit juices, and the like, and mixtures thereof.

### Beverage Compositions

In some embodiments, the potentiator compositions may reside in a beverage composition including at least one active substance including the sweetener composition produced by the method of the invention and at least one taste potentiator. Beverages suitable for use herein include, for example, soft or carbonated drinks, juice-based drinks, milk-based drinks, beverages made from brewed components such as teas and coffees, beverage mixes, beverage concentrates, powdered beverages, beverage syrups, frozen beverages, gel beverages, alcoholic beverages, and the like.

The beverages may include any of the potentiator compositions described herein. In general, the potentiator compositions are present in the beverage compositions in amounts of about 0.001% to about 0.100%, in some embodiments about 0.02% to about 0.08% or about 0.04% to about 0.06% by weight of the beverage composition.

Of course, the required concentrations will depend upon the nature of the beverage to be sweetened, the level of sweetness required, the nature of any additional sweetener(s) in the product and the degree of enhancement required.

In some embodiments, some or all of the active and/or the taste potentiator may be employed in a free form (e.g., unencapsulated). Alternatively, the beverage composition may include some or all of the active and/or the taste potentiator in an encapsulated form. As a further alternative, the beverage composition may include some of the active and/or the taste potentiator in a free form and some of the active and/or the taste potentiator in an encapsulated form. In some embodiments, the beverage composition may include two or more potentiator compositions.

### Juice-Based Compositions

Juice-based compositions generally contain a juice component obtained from fruit or vegetable. The juice component can be used in any form such as a juice form, a concentrate, an extract, a powder, or the like.

Suitable juices include, for example, citrus juice, non-citrus juice, or mixtures thereof, which are known for use in beverages.

Unless otherwise indicated, juice as used can include fruit or vegetable liquids containing a percentage of solids derived from the fruit or vegetable, for example pulp, seeds, skins, fibers, and the like, and pectin, which is naturally occurring in the fruit or vegetable. The amount of solids in the juice can be about 1 to about 75 wt %, or about 5 to about 60 wt %, in some instances about 10 to about 45 wt %, or alternatively about 15 to about 30 wt % each based on the total weight of the juice. Higher concentrations of solids can be found in juice concentrates, purees, and the like.

The amount of juice component present in the juice-based composition generally can be about 0.1 wt % to about 95 wt % based on the total weight of the composition, alternatively about 5 wt % to about 75 wt %, or about 10 wt % to about 50 wt % each based on the total weight of the composition. Amounts may vary depending upon whether the composition is a concentrate or a ready to drink beverage, for example. The remaining components in the juice-based composition can be added water or other suitable liquid, a sweetening agent, a flavoring agent, or other additives as described herein.

The juice-based composition can be non-carbonated or carbonated.

### Milk-Based Compositions

Milk-based compositions generally contain a dairy component which can contain varying amounts of milk proteins (e.g., casein, whey protein, and the like), fats, lactose, and water. Exemplary dairy components include yogurt, cream, whole milk, low or reduced fat milk, skim milk, milk solids, condensed milk, or a combination comprising at least one of the foregoing dairy components.

In some embodiments, non-dairy components may replace part or all of the dairy components in the milk-based composition. Suitable non-dairy components include soy milk, almond milk, coconut milk, rice milk, and the like, or a combination comprising at least one of the foregoing.

### Alcoholic Compositions

The compositions described herein may further comprise an alcoholic composition. Examples of suitable alcoholic compositions include beer, spirit, liqueur, wine, or a combination comprising at least one of the foregoing. In some embodiments, the level of alcohol, as measured by the amount of ethanol contained in the beverage composition can be about 0.5 vol % to about 20 vol % based on the total volume of the beverage composition.

### Carbonated Compositions

A carbonated beverage composition typically contains about 0.1 to about 5.0 volumes of gas or gasses, typically carbon dioxide, per volume of the beverage composition. The carbonation can be effected by forceful introduction of the gas under pressure to the beverage composition. Cooling the beverage composition allows for greater amounts of carbon dioxide to be solubilized by the beverage composition. Carbonation can be used to enhancing the flavor, sweetness, taste, and mouth-feel of the composition. Additionally, carbonation lowers the pH of the composition.

In one embodiment, the carbonation can be added to the finished, noncarbonated beverage composition, which contains all of the desired beverage components.

In some embodiments, carbonation can be added at the point of consumption. For example, in a restaurant or convenience store, a fountain beverage consisting of a beverage syrup and a source of carbonation is prepared for imminent consumer consumption.

### Frozen Compositions

A “frozen beverage composition” as used herein includes a beverage composition having ice crystals suspended therein to provide a viscous, yet drinkable beverage. The consistency of the frozen beverage composition allows it to have a “slushy” or “spoonable” consistency. The ice crystals can be present in the frozen beverage composition in an amount of about 20 to about 90 wt %, in some embodiments about 30 to about 70 wt %, alternatively about 40 to about 50 wt % ice solids each based on the total weight of the frozen beverage composition.

Due to the lower temperature of the frozen beverage composition compared with other beverages, choice in the amount of flavoring agent and/or sweetening agent can be different. Suitable amounts of flavoring agent and sweetening agent can be selected by one of ordinary skill in the art without undue experimentation.

### Gel Compositions

A “gel beverage composition” as used herein includes a beverage composition having a thickening agent to provide a viscous, yet drinkable beverage. The consistency of the gel beverage composition allows it to have a “semi-solid” or “spoonable” consistency. Thickening agents (sometimes referred to as hydrocolloids) can include, but are not limited to natural and synthetic gums, for example locust bean gum, guar gum, gellan gum, xanthan gum, gum ghatti, modified gum ghatti, tragacanth gum, carrageenan, and the like; natural and modified starches, for example pregelatinized starch (corn, wheat, tapioca), pregelatinized high amylose-content starch, pregelatinized hydrolyzed starches (maltodextrins, corn syrup solids), chemically modified starches such as pregelatinized substituted starches (e.g., octenyl succinate), and the like; cellulose derivatives, for example carboxymethylcellulose, sodium carboxymethylcellulose, and the like; polydextrose; whey or whey protein concentrate; pectin; gelatin; or a combination comprising at least one of the foregoing thickening agents.

Due to the textural difference of the gel beverage composition compared with other beverages, choice in the amount of flavoring agent and/or sweetening agent can be different. Suitable amounts of flavoring agent and sweetening agent can be selected by one of ordinary skill in the art without undue experimentation.

Any of the beverage compositions described herein may include flavors and optional sweeteners in addition to the sweetener composition produced by the method of the invention and a variety of optional additives. In some embodiments, the composition may include optional additives such as antioxidants, amino acids, caffeine, coloring agents (“colorants”, “colorings”), emulsifiers, flavor potentiators, food-grade acids, minerals, micronutrients, plant extracts, phytochemicals (“phytonutrients”), preservatives, salts including buffering salts, stabilizers, thickening agents, medicaments, vitamins, or a combination comprising at least one of the foregoing additives. Those of ordinary skill in the art will appreciate that certain additives may meet the definition or function according to more than one of the above-listed additive categories.

Suitable food-grade acids for use in the composition include, for example, acetic acid, adipic acid, ascorbic acid, butyric acid, citric acid, formic acid, fumaric acid, glyconic acid, lactic acid, malic acid, phosphoric acid, oxalic acid, succinic acid, tartaric acid, or a combination comprising at least one of the foregoing food-grade acids. The food-grade acid can be added as acidulant to control the pH of the beverage and also to provide some preservative properties; or to stabilize the beverage.

Suitable amounts of colorant to provide the desired visual effect can be selected by one of ordinary skill in the art without undue experimentation using guidelines provided. Exemplary amounts of coloring agents can be about 0.005 to about 15 wt %, in some embodiments about 0.01 to about 6 wt %, or about 0.1 to about 2 wt % each based on the total weight of the composition.

Emulsifiers can be added to the composition to prevent separation of the composition components by keeping ingredients dispersed. Emulsifiers can include molecules which have both a hydrophilic part and a hydrophobic part. Emulsifiers can operate at the interface between hydrophilic and hydrophobic materials of the beverage to prevent separation of the components of the composition.

The beverage composition may contain an emulsifier in an amount of about 0.001% to about 2.00%, or about 0.005% to about 1.00%, in some embodiments about 0.01% to about 0.5%, or about 0.05% to about 0.1% by weight of the composition.

Certain components (sometimes referred to as hydrocolloids) that act as thickening agents which can impart added “mouth-feel” to the composition include natural and synthetic gums, for example locust bean gum, guar gum, gellan gum, xanthan gum, gum ghatti, modified gum ghatti, tragacanth gum, carrageenan, and the like; natural and modified starches, for example pregelatinized starch (corn, wheat, tapioca), pregelatinized high amylose-content starch, pregelatinized hydrolyzed starches (maltodextrins, corn syrup solids), chemically modified starches such as pregelatinized substituted starches (e.g., octenyl succinate), and the like; cellulose derivatives, for example carboxymethylcellulose, sodium carboxymethylcellulose, and the like; polydextrose; whey or whey protein concentrate; pectin; gelatin; or a combination comprising at least one of the foregoing thickening agents.

The composition may contain a thickening agent in an amount of about 0.001% to about 10%, or about 0.005% to about 5%, in some embodiments about 0.01% to about 1%, or about 0.05% to about 0.5% by weight of the composition.

Preservatives, including antimicrobials, can be added to the composition to provide freshness and to prevent the unwanted growth of bacteria, molds, fungi, or yeast. The addition of a preservative, including antioxidants, may also be used to maintain the composition's color, flavor, or texture. Any suitable preservatives for use in food and beverage products can be incorporated into the compositions.

The composition may be fortified or enriched with vitamins, minerals, micronutrients, or other nutrients. Micronutrients can include materials that have an impact on the nutritional well being of an organism even though the quantity required by the organism to have the desired effect is small relative to macronutrients such as protein, carbohydrate, and fat. Micronutrients can include, but are not limited to vitamins, minerals, enzymes, phytochemicals, antioxidants, and combinations thereof.

The amount of vitamins or minerals provided in the compositions may be up to or exceeding amounts generally recognized as U.S. Recommended Daily amounts or the Recommended Daily Intake amounts established by the U.S. Food and Drug Administration.

In some embodiments micronutrients may include but are not limited to L-carnitine, choline, coenzyme Q10, alpha-lipoic acid, omega-3-fatty acids, pepsin, phytase, trypsin, lipases, proteases, cellulases, and combinations thereof.

Antioxidants may include materials that scavenge free radicals.

Various herbals, aromatic plants or plant parts or extracts thereof, also may be included in the compositions for a variety of reasons such as for flavor or for their potential health benefits.

### Concentrate Compositions

Concentrate compositions may be in dry form (e.g., powder or tablet) or in liquid form (e.g., syrup, suspension, or emulsion). Concentrate compositions typically include the flavoring agent in a volume of liquid medium that is less than the volume of liquid medium found in the finished beverage. Other optional components in the concentrate include additional sweetening agents, coloring agents, and other additives such as food-grade acids, preservatives, and the like. The bulk of the liquid component of a finished beverage composition is not present in the concentrate to allow for reduced weight, volume, storage and shipping costs while at the same time allowing for increased shelf life of the concentrate versus beverage composition.

In one embodiment, the concentrate composition is formulated to provide final beverage compositions upon dilution with about a 2-fold to about a 5-fold by volume, or about 3-fold to about a 4-fold by volume of a liquid. The liquid may be water, juice, dairy component, a non-dairy milk, ethanol, a combination comprising at least one of the foregoing, and the like. The liquid may be in noncarbonated or carbonated form.

In order that the present invention may be more readily understood, reference will now be made to the following examples.

### EXAMPLE 1

### Heating of Lo Han Guo (Momordica 80% Supplied by Amax Nutrasource)

The constituent ingredients of mixture A, as shown in Table 1 below were added to a volumetric flask. Likewise the constituents of a second mixture B were added to a second volumetric flask. Each flask was placed on a stirrer and its contents mixed until the solid ingredients dissolved.

TABLE 1
Heating of a solution formulated with LHG

| | | A | | B | |
|---|---|---|---|---|---|
| Ingredient | Supplier | % w/v | g/1000 ml | % w/v | g/1000 ml |
| Momordica | Amax | 0.0340 | 0.3395 | 0.0648 | 0.648 |
| (80%) LHG | Nutrasource | | | | |
| Citric acid | Jungbunzlauer | 0.200 | 2.000 | 0.200 | 2.000 |
| Sodium | Tate and Lyle | 0.040 | 0.4000 | 0.040 | 0.400 |
| citrate | | | | | |
| Erythritol | Cargill | — | — | 3.000 | 30.000 |
| Magnesium | Aldrich | — | — | 0.0206 | 0.206 |
| gluconate | | | | | |
| Water | Highland | to 100 | to 1000 | to 100 | to 1000 |
| | Spring | | | | |

500 g of each batch A and B was placed in a beaker and the weight of the beaker and solution recorded. Each batch was heated to 90° C. in a microwave. Water was added to replace that which had been lost during heating and the solutions were covered with film to prevent further loss of water vapor and placed in the fridge to cool.

When comparing the taste of the solutions A and B pre and post heating, some differences in flavor were noted. The off flavors of the LHG extracts were less intense in the heated sample compared to the unheated sample.

Overall the heated samples had a more rounded upfront sweetness which was less lingering in the aftertaste. There was a reduced intensity of off flavors and so were preferred to the unheated sample.

### EXAMPLE 2

### Different Heating Methods

The constituent ingredients of mixture C, as shown in Table 2 below, were added to a volumetric flask. Likewise the constituents of a second mixture D, as shown in Table 2 below, were added to a second volumetric flask. Each flask was placed on a stirrer and its contents mixed until the solid ingredients dissolved.

TABLE 2
LHG formulated in an acidified and neutral system

| | |
|---|---|
| C | D |

| Ingredient | % w/v | g/2000 ml | % w/v | g/2000 ml |
|---|---|---|---|---|
| Lo han guo | 0.0648 | 1.2963 | 0.0648 | 1.2963 |
| Citric acid | 0.200 | 4.0000 | | |
| Sodium citrate | 0.040 | 0.8000 | | |
| Water | To 100 | To 2000 | To 100 | To 2000 |

500 g of each batch C and D was placed in a beaker and the weight of the beaker and solution recorded. Samples of each batch were taken and (other than a control sample which was not heated) were heated to 90° C. in the manner indicated below. Water was added to replace that which had been lost during heating, the solutions were covered to prevent further loss of water vapor and placed in the fridge to cool.

The heating methods used were as follows: —

(i) Control—unheated
(ii) Heating in an open beaker to 90° C. in a microwave.
(iii) Heating in a water bath to 90° C.
(iv) Heating in a water bath to 90° C. whilst covered with a lid.

The effect on the taste profile of samples C and D is shown in Table 3 below.

TABLE 3
Comparison of different heating methods

| Heating | | |
|---|---|---|
| method | Acidified solution C | Neutral solution D |
| (i) | Typical LHG off flavors. | Typical LHG off flavors. |
| Control | Delayed onset of sweetness | Icing sugar type sweetness. |
| (Un- | and lingering sweetness in | Cereal note. |
| heated) | the aftertaste. | |
| (ii) | Sharp and astringent. | LHG off flavors were reduced |
| Micro- | Icing sugar type sweetness. | in intensity. |
| wave | Red fruit note. | Lingering sweetness remained.. |
| | LHG off flavors were | Red fruit notes and praline/ |
| | reduced in intensity. | nutty notes present. |
| (iii) | LHG off flavors were | LHG off flavors were |
| Open | reduced in intensity. | reduced. |
| water bath | Red fruit notes present. | Red fruit notes present. |
| | More rounded and upfront | More rounded and upfront |
| | sweetness. | sweetness. |
| | Less lingering sweetness. | Less lingering sweetness. |
| | Cleaner flavor. | Cleaner flavor. |
| (iv) | Slight reduction in LHG | Slight reduction in LHG |
| Closed | off flavors. | off flavors. |
| water bath | Red fruit note present, | Red fruit note present, |
| | which was not as strong as | which was not as strong as |
| | open pan method. | open pan method. |
| | Delayed onset of sweetness | Delayed onset of sweetness |
| | and lingering sweetness in | and lingering sweetness in |
| | the aftertaste. | the aftertaste. |

It was noted that the acidified solutions were a lighter yellow in color than the neutral solutions. The acidified solution produced an upfront sweetness, which had a cleaner aftertaste.

The open pan method had the most impact in improving LHG flavor. It provided a cleaner more upfront sweetness profile.

### EXAMPLE 3

### Heating at Different Temperatures

500 g batches of solutions C and D from Example 2 were each placed in a beaker and the weight of each beaker and solution recorded. Each batch was heated to the desired temperature in a water bath without a cover. Water was added to replace that which had been lost during heating, the solutions were covered to prevent further loss of water vapor and placed in the fridge to cool.

The effect of heating temperature on the taste profile of samples C and D is shown below in Table 4.

TABLE 4
Observations on open pan heating to various temperatures.

| Temperature | Acidified solution C | Neutral solution D |
|---|---|---|
| 50° C. | Typical LHG off | Typical LHG off |
| | flavors. | flavors. |
| 70° C. | Reduction in LHG off | Reduction in LHG off |
| | flavors. | flavors. |
| | Slight red fruit note | Slight red fruit note. |
| | present. | |
| 80° C. | Cleaner profile. | Cleaner profile. |
| | Reduction in LHG off | Reduction in LHG off |
| | flavors. | flavors. |
| | Red fruit note present. | Red fruit note present. |
| | More rounded | More rounded |
| | sweetness profile. | sweetness profile. |
| 90° C. | Cleaner profile. | Cleaner profile. |
| | LHG off flavors | LHG off flavors |
| | reduced significantly. | reduced significantly. |
| | Red fruit note present. | Strong red fruit note. |
| | More rounded | More rounded |
| | sweetness profile. | sweetness profile. |

It was noted that there were significant changes in the LHG flavor profile when heated to 70° C. and above. This resulted in a cleaner profile and a reduction in off flavors. The sweetness profile is more rounded, upfront and less lingering. A red fruit note is detected in the flavor profile.

### EXAMPLE 4

### Different Holding Times at 90° C.

A portion of sample C, from examples 2 and 3, was added to a volumetric flask and stirred. The mixture was placed on stirrer and mixed until the solid ingredients dissolved.

500 g of each batch was placed in a water bath and the weight of the solution recorded. This was heated to 90° C. without a cover, and immediately removed from the heat source. Water was added to replace that which had been lost during heating. The solutions were covered with to prevent further loss of water vapor and placed in the fridge to cool.

The method was repeated for new batches of Sample C and held at 90° C. for 5 minutes, and 7.5 minutes.

Overall by increasing the heating time, the LHG off-flavor was reduced further resulting in a cleaner flavor. A reduction in sweetness intensity was noted as the time period increased.

### EXAMPLE 5

### Controlling a Closed Pan System

For the controlled method of Example 5, a Duran bottle had a hole in the lid allowing a temperature probe to fit through into the solution. The lid was sealed, preventing any evaporation. The Duran bottle was placed in a water bath, allowing the LHG solution to be heated to 90° C.

The ingredients of Sample C of Example 3 was added to a volumetric flask, placed on a stirrer and mixed until the solid ingredients dissolved.

500 g of each batch was placed in a sealed glass jar, placing a temperature probe inside. The jar was placed in a water bath, and the weight of the solution recorded. This was heated to 90° C. without a cover. Water was added to replace that which had been lost during heating. The solutions were covered to prevent further loss of water vapor and placed in the fridge to cool.

No differences were detected between heated and unheated solutions. It was clear that the off-flavor volatiles did not escape into the atmosphere in these sealed conditions.

### EXAMPLE 6

### Heating LHG Purified by Chromatography

LHG was purified by preparative HPLC, and included in a formulation E (as shown in Table 5 below). The typical LHG off flavors were still present in the purified sample at a lower level than unpurified samples.

TABLE 5
Purified LHG formulations

E

| Ingredient | % w/w | g/200 ml |
|---|---|---|
| Purified LHG | 0.0648 | 0.1296 |
| Citric acid | 0.200 | 0.4 |
| Sodium citrate | 0.040 | 0.08 |
| Water | To | To |
| | volume | volume |

LHG, as purified by preparative HPLC, was added to a volumetric flask along with remaining ingredients of sample E. The mixture was placed on stirrer and mixed until the solid ingredients dissolved.

100 g of the batch of Sample E was placed in a water bath. The weight of the solution was recorded. The solution was heated to 90° C. in a microwave. Water was added to replace that which had been lost during heating. The solutions were covered to prevent further loss of water vapor and placed in the fridge to cool.

The unheated purified LHG solution had an aromatic icing sugar sweetness profile. There was still a slight LHG off flavor present. On heating the LHG off flavor and icing sugar type sweetness was reduced.

### EXAMPLE 7

### Heating Solution in an Open Pan for Differing Lengths of Time

Various LHG solutions made according to Sample C were heated to 90° C. and held for different periods of time, from 0 to 10 minutes, in a water bath.

The flavor profile of the LHG solution improved for heating duration up to 4 minutes. The intensity of the LHG off flavors was reduced. A red fruit note was detected. The sweetness was also less lingering and more rounded. Holding for longer than 4 minutes resulted in a reduction in sweetness intensity, without further reduction in LHG notes.

It is to be understood that the invention is not to be limited to the details of the above embodiments, which are described by way of example only. Many variations are possible.

1. A method of improving the taste of an extract of a fruit from the Cucurbitaceae family provided as a liquid comprising the extract, said method comprising heating the liquid to a temperature above 60° C. such that at least one off-flavor material is removed by evaporation.

2. The method of claim 1, wherein the extract of a fruit from the Cucurbitaceae family comprises Lo Han Guo.

3. The method of claim 1, wherein the extract of a fruit from the Cucurbitaceae family is in the form of a solid which is solvated in water so as to be provided as the liquid.

4. The method of claim 1, wherein the liquid is heated to a temperature of at least 65° C.

5. The method of claim 1, wherein the liquid is heated to a temperature of at least 70° C.

6. The method of claim 1, wherein the liquid is heated to a temperature of at least 80° C.

7. The method of claim 1, wherein heating of the liquid takes place in a system which is open to the atmosphere.

8. The method of claim 1, wherein heating of the liquid takes place in a system providing for removal of evaporated off-flavor material.

9. The method of claim 1, wherein the duration of the heating is in the range from 1 second to 10 minutes.

10. The method of claim 8, wherein the method comprises distillation.

11. The method of claim 1, wherein the pH of the liquid is in the range from 5.5 to 8.5.

12. The method of claim 1, wherein the liquid comprises at least one sugar alcohol.

13. The method of claim 1, wherein the liquid comprises at least one organic salt.

14. The method of claim 1, wherein the liquid comprises at least one saccharide.

15. A method of making a beverage or a foodstuff, the method comprising heating a liquid comprising an extract of a fruit from the Cucurbitaceae family to a temperature above 60° C. such that at least one off-flavor material is removed by evaporation.
